(19) United States
(12) Patent Application Publication
(10) Pub. No.: US 2020/0150717 A1
(43) Pub. Date: May 14, 2020

(54) INTERACTIVE SURFACES WITH ACCESSORY COVERS

(71) Applicant: HEWLETT-PACKARD DEVELOPMENT COMPANY, L.P., Spring, TX (US)

(72) Inventors: Dimitre D Mehandjiysky, Houston, TX (US); Sara R Ferris, Houston, TX (US); Kevin L Massaro, Houston, TX (US)

(21) Appl. No.: 16/478,964

(22) PCT Filed: Jul. 28, 2017
(86) PCT No.: PCT/US2017/044523

§ 371 Date: Jul. 18, 2019

(51) Int. Cl. G06F 1/16; G06F 21/32

(52) U.S. Cl. CPC G06F 1/1607; G06F 21/32; G06F 1/1613

(57) ABSTRACT

An interactive surface system includes an interactive device with a front interactive surface region, a back region, a first coupling mechanism, a printed circuit board (PCB), and an accessory cover including a microchip, a second coupling mechanism, and a cover profile associated with the accessory cover. In a first state, the interactive device is to associate with a first functionality. In a second state, the accessory cover is to removably couple to the front interactive surface region via the first and second coupling mechanisms. In the second state and in response to the coupling, the interactive device is to load the cover profile based on at least one of the second coupling mechanism and the microchip and is associated with a second functionality.

### BACKGROUND

Computing devices may have touch-sensitive screens that enable users to interact directly with the computing device using their fingers or using specialized devices or other devices that enable inputs to be received by the computing device. These input products may be add-ons to computer systems and may be configured towards drawing and graphics applications.

### BRIEF DESCRIPTION OF THE DRAWINGS

Various examples will be described below referring to the following figures:

FIG. 1 is a partial schematic illustration of an interactive device in an example interactive surface system in accordance with various examples.

FIGS. 2A-2D are partial schematic illustrations of examples of assembled interactive systems with varying accessory cover dimensions as compared to the dimension of the interactive device in accordance with various examples.

FIGS. 3A-3F are partial schematic illustrations of coupling mechanisms of interactive devices in accordance with various examples.

FIGS. 4A-4F are partial schematic illustrations of coupling mechanisms of interactive devices in accordance with various examples.

FIG. 5 is a partial schematic illustration of an active accessory cover in accordance with various examples.

FIG. 6 is a partial schematic illustration of a passive accessory cover in accordance with various examples.

FIGS. 7 and 8 are partial schematic illustrations of an interactive surface system in accordance with various examples.

FIG. 9 is a flowchart of a method of using an interactive surface system in accordance with various examples.

### DETAILED DESCRIPTION

As used herein, an “interactive surface” comprises any substrate or combination of substrates capable of communicating with peripheral devices to display markings resulting from the communication between the surface and the peripheral device. This is in contrast to a conventional writing surface, such as paper, a whiteboard, or a blackboard, where the markings may be left by a peripheral device such as a marker or piece of chalk.

As used herein, an “interactive device” is any device that comprises an interactive surface.

As used herein, the term “markings” may be used to collectively describe freehand-originated features such as text, drawings, stamps, images, and typeface text that may be imported from peripheral devices, as well as combinations thereof. Thus, a marking would include an image imported to an interactive surface that is then modified by, for example, freehanded writing to emphasize, modify, or deemphasize various features of the image.

As used herein, the phrase “substantially similar” may be used to define measurements such as height, depth, length, thickness, volume, radius of curvature, relative position along one or more axes, or mass such that the two or more measurements that are “substantially similar” differ by such a small percentage that any difference in measurement is without a negative functional impact.

As used herein the term “passive” as it relates to an accessory cover may be used to mean an accessory cover that comprises a coupling mechanism and may comprise a microchip, but does not comprise a motor or a battery.

As used herein the term “active” as it relates to an accessory cover may be used to mean a passive accessory cover that additionally comprises a motor and/or a battery.

The interactive surface system discussed herein comprises an interactive device with an interactive surface that may be removably coupled to multiple accessory covers. This coupling enhances the functionality of the interactive device itself as well as the functionality of the interactive device when it is in communication with a mobile or stationary computing device, for example, via a hard line, NFC, BlueTooth, WiFi, or other technologies. Previously designed input products such as electronic pens, interactive surfaces, musical devices, and gaming equipment may be add-ons to a desktop, laptop, tablet, wearable technology, or other device. These input products may take up desk space, employ messy cables, and create a variety of challenges for the user, including a lack of an integrated display and presentation as an opaque surface. Thus, the user either uses the input product in isolation, or views a remote device such as a monitor while sketching on a surface far below it which may not be an optimal experience for the user.

The interactive device is to couple to both accessory covers designed and manufactured by the interactive device manufacturer, and also to couple to a plurality of accessory covers developed based on a platform that supports the interactive device and interactive surface systems, thus enabling third-party developers to design and sell accessory covers to owners of the interactive devices. The interactive device may be powered while plugged in to a power source, and in some examples may be hard-lined in to a separate computing device and/or dock for a separate computing device. In another example, the interactive device may be wireless to communicate with multiple accessory covers and computing devices without being hard-lined into a power source or computing device. The interactive device may or may not comprise an inactive border region in addition to an active interactive surface. The interactive surface may be transparent, opaque, semi-transparent, and/or adjustable, for example, given ambient light conditions in the location of use.

In one example, the accessory covers may removably couple to the interactive device via the coupling mechanisms of each of the accessory covers and interactive devices. These accessory covers may be described as passive, comprising mechanical functions, the coupling mechanism, and, in some cases, a microchip and/or a passive RFID chip. In one example, a passive accessory cover is a keyboard accessory cover that turns the interactive surface into a keyboard. In another example, the accessory covers may be described as active, and contain the elements of the passive cover in addition to integrated electronics, which may include at least one of a battery, a motor, a printed circuit board (PCB), a non-transitory memory, an application stored in the non-transitory memory, Bluetooth, RFID, Wi-Fi, and/or NFC capabilities, and a plurality of sensors and/or haptics. In one example of an active cover, the cover may comprise at least one modular part that may disassemble from the base active cover in order to be used. In this example, the cover may still maintain its own functionality while the system gains an additional functionality via the activated module upon removal. In some examples, activation of the module and/or the active cover may additionally include authentication or activation of buttons on the module or cover. These modules may comprise elements such as a battery, a motor, a PCB, a non-transitory memory, an application stored in the non-transitory memory, and/or a plurality of sensors, that are separate and distinct from similarly-functioning elements in the active cover.

In one example, the active cover may be powered while plugged in to a power source, and may be hard-lined in to a separate computing device and/or dock for a separate computing device. In another example, the active cover may be wireless. In one example, the active cover magnetically couples to the interactive device. The magnets may have multiple functions, including information storage. The information stored may comprise information associated with the active cover, and may be read by an application and/or the coupling mechanism of the interactive device. In some examples, the information and functionalities subsequently loaded may be referred to as a cover profile. Active accessory covers may be associated with downloadable applications and drivers that are stored remotely and are available for any operating system (e.g., the apps and drivers are OS-agnostic), and compatible interactive devices may be sold in conjunction with a developer kit to enable third party development of accessory covers. These third parties may also develop accessory covers that couple to covers or interactive devices manufactured by other parties.

This information stored on the cover may comprise a state of the cover (active/inactive), a model, a manufacturer, a brand, a plurality of functionalities (markings, sound, motion, power, graphical user interface, etc.), an indication of modularity, and a plurality of use rules, such as those that limit the use of the accessory cover based on biometric inputs. A biometric input, in some examples discussed herein, may cause a user profile to be loaded on to an interactive device. The user profile may have been previously stored, and the interactive device may comprise a plurality of stored user profiles. In another example, the user profiles may be retrieved from a remote server by an application on the interactive device. The user profile may comprise a plurality of previously used accessory covers, a plurality of allowed-access accessory covers, a plurality of disallowed accessory covers, a user age, a user geolocation, and other information associated with the user's preferences for the interactive device such as ambient light and font settings.

In an example, via a plurality of polarity maps, the magnets may help the accessory covers self-register into a desired position, e.g., into a relative alignment with the interactive device which may or may not encompass the entirety of the interactive surface of the interactive device. The coupling mechanisms may cause an auto-alignment, both based upon their respective locations on/in the cover and on/in the interactive device. This auto-alignment may be along any axis or along multiple axes. The magnets thus enable not only correct positioning but also enable the interactive device to register that there is a specific accessory being added, which may automatically trigger adjustment of the user interface (UI) to reflect the cover's function, and may in some cases trigger the downloading of a driver associated with the cover to the interactive device and/or the computing device to which the interactive device is coupled.

Example accessory covers may include passive covers such as keyboard covers with tactile sensations (haptics), DJ turntables, musical instruments, gaming covers, interactive health and nutrition covers, covers associated with business applications, and covers which may function as docking stations between the interactive device and a remote computing device, including wearable technology. Features such as integrated video playback and speakers/microphones may be included in various accessory covers, as may gaming features such as joysticks, steering wheels, and other peripheral gaming devices. The platform on which the system operates enables third parties to design and program (for active covers) accessory covers. These may be fabricated via 3D printing, where coupling mechanisms added to the 3D print can enable smart functionality via information storage.

In an example, an interactive surface system includes an interactive device with a front interactive surface region, a back region, a first coupling mechanism, a printed circuit board (PCB), and an accessory cover including a microchip, a second coupling mechanism, and a cover profile associated with the accessory cover, wherein, in a first state, the interactive device is to associate with a first functionality, wherein in a second state, the accessory cover is to removably couple to the front interactive surface region via the first and second coupling mechanisms, and wherein, in the second state and in response to the coupling, the interactive device is to load the cover profile based on at least one of the second coupling mechanism and the microchip and is associated with a second functionality. The cover profile may be stored on the second coupling mechanism. The cover profile may be stored on the microchip. The interactive device may be associated with a first height and a first width and the accessory cover may be associated with a second height and a second width. At least one of the first height and the first width may be different from both the second height and the second width. The first height may be substantially similar to the second height and the first width may be substantially similar to the second width.

In an example, an interactive surface system includes an interactive device with a front interactive surface region, a back region, a first coupling mechanism, a printed circuit board (PCB), and a cover including a microchip, a second coupling mechanism, a motor, a battery coupled to the motor, and a cover profile, wherein, in a first state, the interactive device is to associate with a first functionality, wherein, in a second state, the cover is to removably couple to the front interactive surface region via the first and second coupling mechanisms, and wherein, in the second state and in response to the coupling, an application stored on the interactive device and executable by a processor is to load the cover profile based on at least one of the second coupling mechanism and the microchip and is associated with a second functionality. The front interactive surface region may extend to an outer edge of the interactive device and include the first coupling mechanism. A portion of the front interactive surface region may extend to an inactive border region. The inactive border region may include the first coupling mechanism. When configured in the second state, the battery of the cover may power the motor. The system may further include a biometric sensor, wherein the application is to receive an input via the biometric sensor, and wherein the application is to load the cover profile further based on the input received.

In an example, a method of use of an interactive surface system includes loading, by an application stored in a non-transitory computer-readable medium of an interactive device, a cover profile stored in an accessory cover, wherein the interactive device comprises an interactive surface and a first coupling mechanism to removably couple to a second coupling mechanism of the accessory cover, wherein the cover profile is to be loaded in response to the accessory cover being removably coupled to the interactive device, executing, by the application and subsequent to loading the cover profile and in response to receiving a plurality of inputs from the accessory cover, at least one functionality of the accessory cover, decoupling the accessory cover from the interactive device, and unloading, by the application, the cover profile from the interactive device in response to a determination that the accessory cover is decoupled from the interactive device. The method may further include loading, by the application, a driver associated with the accessory cover based on the cover profile of the accessory cover, wherein the accessory cover profile includes a state of the accessory cover, a model, a manufacturer, a brand, a plurality of functionalities, an indication of modularity, and a plurality of use rules. The method may further include receiving, by the application via a biometric sensor of the interactive device, a biometric input, wherein loading the cover profile further includes loading the cover profile based upon the biometric input.

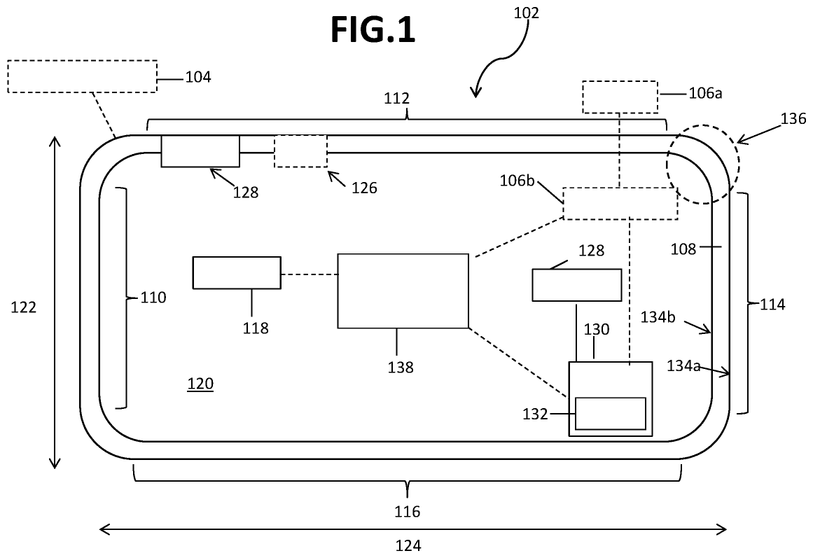

FIG. 1 is a partial schematic illustration of an interactive device in an example interactive surface system. In FIG. 1, the interactive device 102 is in communication with a remote server computer and/or a mobile device 104 such as a laptop, phone, tablet, or wearable technology. This communication may be wired or wireless, such that transmission to the remote device 104 via an application stored in a memory 132 of a PCB 130 is enabled via the communication connection. The interactive device 102 may comprise an interactive surface 120 that may extend to a first edge 134b, and a passive region 108 may be formed in between the first edge 134b of the interactive surface 120 and an outside edge 134a of the device 102. In FIG. 1, this passive region 108 is illustrated as being the circumference of the interactive device 102, but in other examples the passive region 108 may be formed along less than the entire circumference, as defined by the outside edge 134a of the device 102. For example, the interactive region 108 may be present on one or more sides 110, 112, 114, and/or 116, as well as in one or more corner regions 136. In FIG. 1, the interactive device 102 comprises a width 124 and a height 122, and the overall shape of this view of the interactive device 102 comprises a rectangular shape with curved corner 136. In some examples, the width 124 may be from about 4″ to about 18″, and the height may be from about 4″ to about 10″. In other examples, the interactive device 102 may comprise other polygonal shapes, circles, ellipses, or combinations thereof. The interactive device 102 also comprises a thickness, not illustrated in FIG. 1.

In this example, the interactive device 102 further comprises a plurality of inputs 128 which may be configured to couple to the remote device 104 and/or receive a biometric input (e.g., a biometric sensor may have a physical location on the interactive device 102 at 128), and a plurality of physical buttons 126 that may be configured to adjust power off/on, volume, and connectivity options. In alternate examples, the interactive device 102 may be powered on and/or off by biometric inputs received in other locations on the interactive surface 120. The interactive device further comprises a coupling mechanism 118 that may be configured to read, transmit, and/or store information from other sources and to removably couple a plurality of accessory covers (not shown in FIG. 1) to the interactive surface 120. In some examples, the coupling mechanism 118 may comprise a single element, and in other examples, it may comprise multiple elements. In still other examples, the coupling mechanism 118 is not a distinct element or set of elements, but rather a region or plurality of regions on the interactive surface 120 and/or the inactive region 108.

In some examples, the interactive device 102 comprises a battery 106b that may be connected to a power source 106a that is remote from the interactive device 102. In other examples, the interactive device 102 operates wirelessly without being connected to the power source 106a, and in still other examples, the interactive device 102 does not comprise the battery 106b and operates while physically connected to the remote power source 106a. An antenna 128 is in communication with the PCB 130 and may act to transmit information to and receive information from the remote device 104 as well as coupled accessory covers.

Further in this example of the interactive device 102, a plurality of sensors 138 is in communication with at least the coupling elements 118 and the non-transitory memory 132. These sensors 138 may comprise orientation sensors, proximity sensors, temperature sensors, and pressure sensors, and may be configured to receive inputs from the interactive surface 120 both when the interactive device 102 is coupled to accessory covers and when the two components are uncoupled.

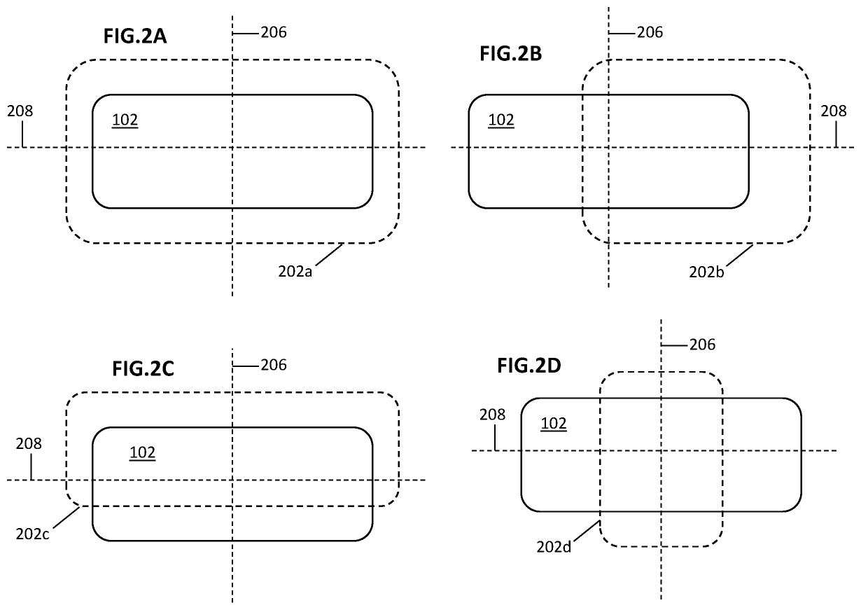

FIGS. 2A-2D are partial schematic illustrations of examples of assembled interactive systems with varying accessory cover dimensions as compared to the dimension of the interactive device 102. The axes 206 and 208 are perpendicular to each other and are illustrated for ease of description of the relative overlap of the accessory covers 202a-202d and the interactive device(s) 102. As discussed in FIG. 1, these are example geometries used to illustrate examples of an assembled interactive system, where the coupling mechanisms 118, as discussed in FIG. 1 and not illustrated in FIGS. 2A-2D, engage with a coupling mechanism of the accessory covers 202a-202d. In one example, as shown in FIG. 2A, an accessory cover 202a is larger than the interactive device 102 (FIG. 2A) such that it fully encompasses the device 102, in contrast with FIGS. 2B-2D. For example, in FIG. 2B, the accessory cover 202b is offset and does not cover all of the device 102, but rather covers a portion of the device 102 along the 208 axis. In FIG. 2C, a portion of the device 102 along the axis 206 remains exposed when it is coupled to the accessory cover 202c, and in FIG. 2D, the example illustrates an accessory cover 202d that couples to a center portion of the device 102 and leaves portions of the device 102 exposed along the axis 208 on either side of the axis 206. In some examples, as discussed below, an accessory cover may have substantially similar dimensions to an interactive device 102 such that, when coupled, there is no visible difference in height and width but there may be a difference in thickness such that the device 102 is thinner than the accessory cover.

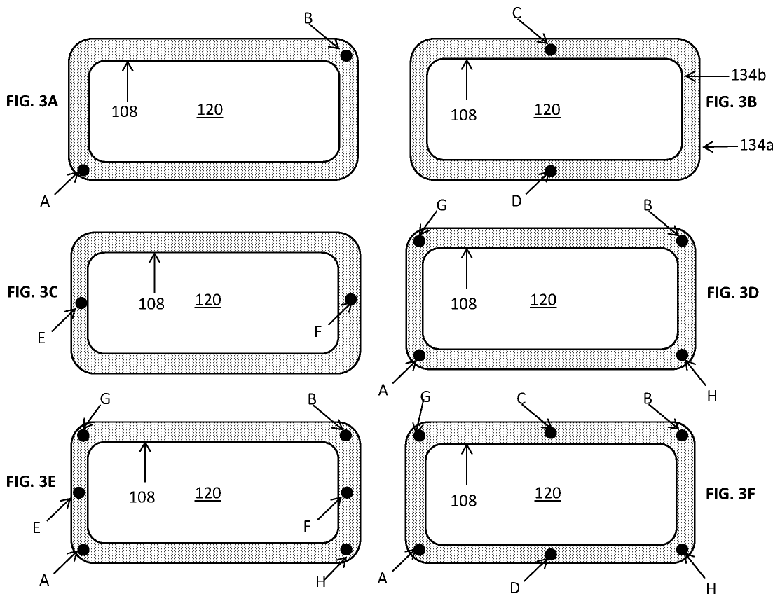

FIGS. 3A-3F are partial schematic illustrations of coupling mechanisms of interactive devices. Each of FIGS. 3A-3F illustrates an interactive device with an interactive surface 120 that has an outer edge 134b (as shown in FIG. 3B for ease of illustration) and a border region 108 with an outer edge 134a. A plurality of positions A-H are defined in FIGS. 3A-3F to illustrate example configurations of the coupling mechanism. FIG. 3A illustrates coupling element locations A and B located in corners such as those corners 136 discussed in FIG. 1. FIG. 3B illustrates a coupling mechanism comprising coupling element locations C and D, formed along parallel sides of the inactive region 108, and FIG. 3C illustrates a coupling mechanism of element locations E and F, formed along parallel sides of the inactive region 108 that are perpendicular to the sides illustrated in FIG. 3B. FIG. 3D illustrates a coupling mechanism of element locations A, B, G, and H, each disposed in a corner region of the inactive region. FIGS. 3E and 3F illustrate examples where coupling mechanisms comprise 6 element locations formed along the inactive region 108. The element locations A-H discussed in FIGS. 3A-3F may comprise discrete elements such as magnets that may be protruding, embedded, or partially (5%-95% of a height of the magnet/element) embedded. In other examples, a single element or plurality of elements may extend from, for example, element location G to element location A, and/or from element location G to element location B, or may wrap around one or more of the corner regions (136 in FIG. 1). In some examples, further element locations may be present in the interactive surface 120.

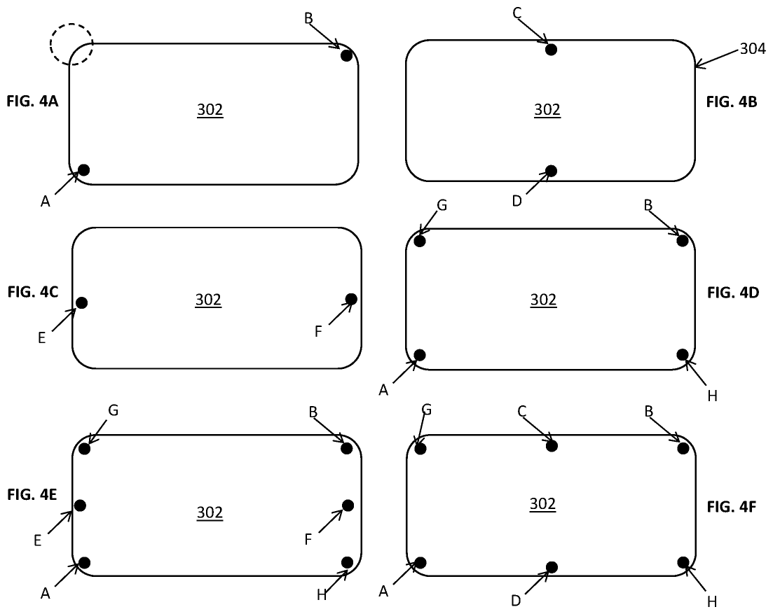

FIGS. 4A-4F are partial schematic illustrations of coupling mechanisms of interactive devices. Each of FIGS. 4A-4F illustrates an interactive device with an interactive surface 120 that does not have a border region, but rather has an outside edge 302 that corresponds to an edge of the device (102 as shown in FIG. 1). A plurality of positions A-H are defined in FIGS. 4A-4F to illustrate example configurations of the coupling mechanism when the coupling elements are located in the interactive surface 120. FIG. 4A illustrates coupling element locations A and B located in corners of the surface 120. FIG. 4B illustrates a coupling mechanism comprising coupling element locations C and D, formed along parallel sides of the interactive surface 120, and FIG. 4C illustrates a coupling mechanism of element locations E and F, formed along parallel sides of the interactive surface 120 that are perpendicular to the sides illustrated in FIG. 4B. FIG. 4D illustrates a coupling mechanism of element locations A, B, G, and H, each disposed in a corner region of the inactive region.

FIGS. 4E and 4F illustrate examples where coupling mechanisms comprise 6 element locations formed along the inactive region 108. The element locations A-H discussed in FIGS. 4A-4F may comprise discrete elements such as magnets that may be protruding, embedded, or partially (5%-95% of a height of the magnet/element) embedded. In other examples, a single element or a region containing a plurality of elements may extend from, for example, element location G to element location A, and/or from element location G to element location B, or may wrap around one or more of the corner regions. In some examples, further element locations may be present in the interactive surface 120, such as locations that are not located in proximity to an outer edge of the device as shown in FIGS. 4A-4F.

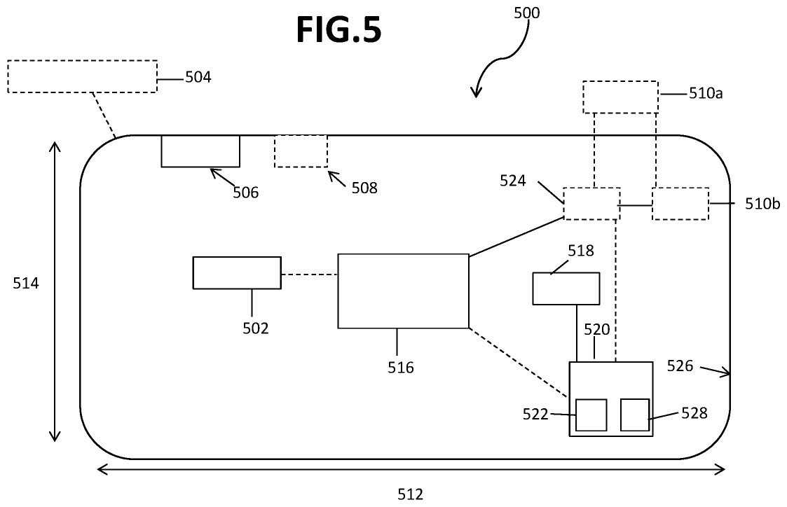

FIG. 5 is a partial schematic illustration of an active accessory cover 500. In the example in FIG. 5, the cover 500 comprises a width 512 and a height 514 that may be greater than, less than, or equal to the width and/or heights of an interactive device to which the accessory cover 500 is coupled. While a rectangular-shaped cover is shown in FIG. 5, other sizes and profiles of covers are employed in other examples as discussed herein. The accessory cover may comprise a coupling mechanism 502, a plurality of sensors 516, a motor 524 that may be electrically and/or mechanically coupled to a battery 510b that may be rechargeable and/or wireless, or that may be wired to an external power source 510a, for example, to charge the battery 510b or other elements of the cover 500. The cover 500 may further comprise a PCB 520, a memory 522, an outside edge 526, and an antenna 518 coupled to the PCB 520. One or more applications (not shown) may be stored in the memory 522 and executable by a processor 528 to communicate with an application stored in a memory of an interactive device. In some examples, the cover 500 may comprise a plurality of inputs 506 for USB, FireWire, and/or other types of connections, and at least one physical button or switch 508.

While a plurality of positions and locations are illustrated for the elements of the coupling mechanism in the example cover 500 in FIG. 5, these elements may be otherwise configured while still being electrically and/or mechanically coupled to preserve functionality. In some examples, the coupling mechanism 502 and/or the memory 522 may store a plurality of information about the active cover 500 that may be referred to as the cover profile. The cover profile may include a state of the cover (active/inactive), a model, a manufacturer, a brand, a plurality of functionalities (markings, sound, motion, power, graphical user interface, etc.), an indication of modularity, and a plurality of use rules. In some examples, a biometric input (and the user profile associated with the biometric input) in combination with the cover profile may be employed. In this example, a biometric input may be associated with a user profile of a minor (under 18 years of age), which may cause a portion of a cover profile to be loaded or a different profile to be loaded than what would be loaded for a party over 18 years of age. This may be associated with a rule of the plurality of information, and may enable users of different ages to access various features, for example, when playing games and/or shopping online.

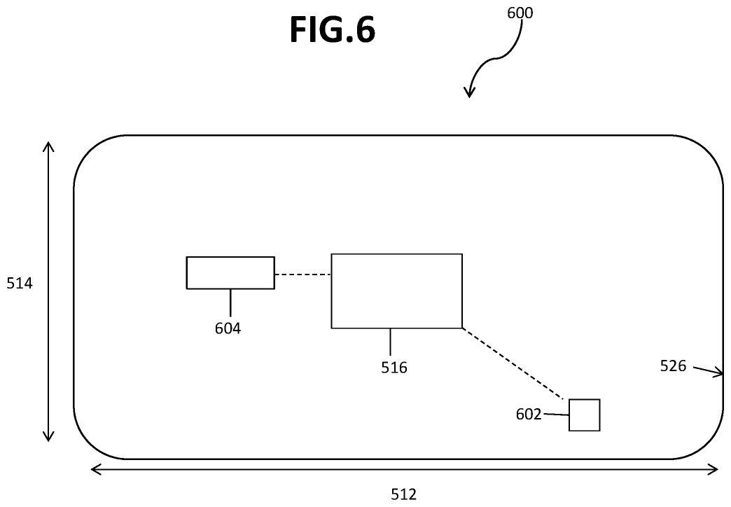

FIG. 6 is a partial schematic illustration of an example accessory cover 600 that is a passive cover 600. The cover 500 in FIG. 5 is an active cover, comprising a motor 524 and a battery 510b. In contrast, the passive cover 600 is configured similarly to the active cover 500 in FIG. 5, but does not have the embedded electronics. For example, passive covers do not comprise the plurality of inputs 506, nor the physical button or buttons 508 that may be used to power the cover 500 on/off, adjust volume, or perform other functions. In this example, the passive cover 600 comprises a coupling mechanism 604 that may store a plurality of information about the passive cover 600, including a state of the cover, a make, a manufacturer, a brand, a model, and a plurality of use rules. Such information may enable and/or cause the interactive device to download drivers from a remote server such as 104 from FIG. 1. In contrast to the active cover 500, the passive cover 600 does not have a battery 510b, a motor 524, an antenna 518, a PCB 520 or a processor 528, but may, in some examples, comprise a passive storage device 602. In one example, the passive cover 600 additionally comprises one or more sensors 516. The coupling mechanism 604 is configured to mate with the coupling mechanisms discussed herein of the interactive device.

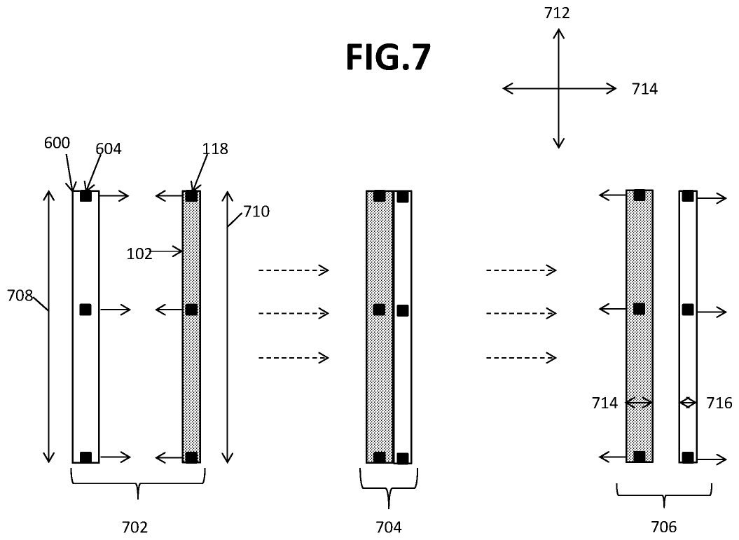

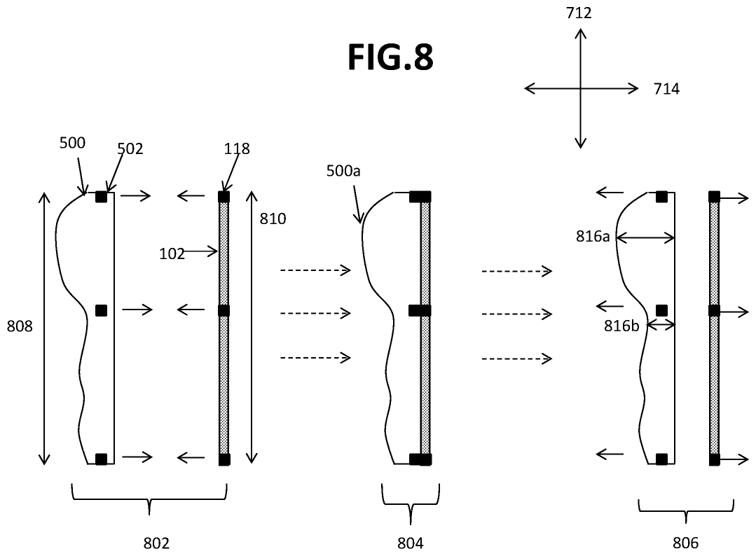

FIGS. 7 and 8 are partial schematic illustrations of an interactive surface system in accordance with various examples. FIG. 7 illustrates a passive cover 600 comprising the coupling mechanism 604 and an interactive device 102 comprising the coupling mechanism 118. As shown in FIG. 7, at block 702, the passive cover 600 and the interactive device 102 are uncoupled and not in contact, but, when in proximity to each other, the coupling mechanisms 604 and 118 are attracted to each other and, at block 704, removably couple the passive cover 600 and interactive device 102.

While FIG. 7 illustrates a passive cover 600 and an interactive device 102 that have respective heights 708 and 710 that are substantially equivalent in this example, in other examples, such as those shown in FIGS. 2A-2D, the respective heights 708 and 710 as well as other dimensions, including thickness, may vary. The cover 600 comprises a thickness 716 and the interactive device comprises a smaller thickness 718. While the ratio of thickness between the cover 600 and the device 102 may vary among and between examples, in one example, the thickness 716 of the cover 600 may be at least more than 10% greater than that of the device 102. As shown in FIG. 7, the cover 600 and interactive device 102 couple along surfaces that are substantially parallel to the axis 712, and are coupled at block 704 and uncoupled at block 706 along the axis 714.

FIG. 8 illustrates an active cover 500 comprising the coupling mechanism 502 and an interactive device 102 comprising the coupling mechanism 118. As shown in FIG. 8, at block 802, the active cover 500 and the interactive device 102 are uncoupled and not in contact, but, when in proximity to each other, the coupling mechanisms 502 and 118 are attracted to each other and, at block 804, removably couple the active cover 500 and interactive device 102. This coupling may comprise alignment along one or more axes such that the cover 500 is flush with at least one of the front surface of the interactive device 102 and/or an edge of the device 102. It is to be understood that, in some examples, the accessory covers 500 and 600 discussed herein are coupled to an interactive surface (front or face) of the interactive device 102 and are not coupled to the back of the device 102 opposite the front surface.

While FIG. 8 illustrates an active cover 500 and an interactive device 102 that have respective heights 808 and 810 that are substantially equivalent in this example, in other examples, such as those shown in FIGS. 2A-2D, the respective heights 808 and 810 as well as other dimensions, including thickness, may vary. The cover 500 comprises a profile 500a of a varying thickness, with a maximum thickness 816a and a minimum thickness 816b. In some examples, this profile 500a may be employed for ergonomic support or accessory storage. In other examples, the active cover 500 may be modular, and one or more modules of the active cover 500 may be decoupled from the cover 500 and employed. In this example, those modules may comprise elements such as a battery, motor, PCB, memory, and/or antenna that are in addition to a primary a battery, motor, PCB, memory, and/or antenna that are configured as shown in FIG. 5 to support the overall functionality of the active cover 500.

Turning back to FIG. 8, the interactive device comprises a thickness of 818 that is less than the minimum thickness 816b of the cover 500. The ratios of thicknesses between the cover 500 and the device 102 may vary among and between examples. As shown in FIG. 8, the cover 500 and interactive device 102 couple along surfaces that are substantially parallel to the axis 712, and are coupled at block 804 and uncoupled at block 806 along the axis 714.

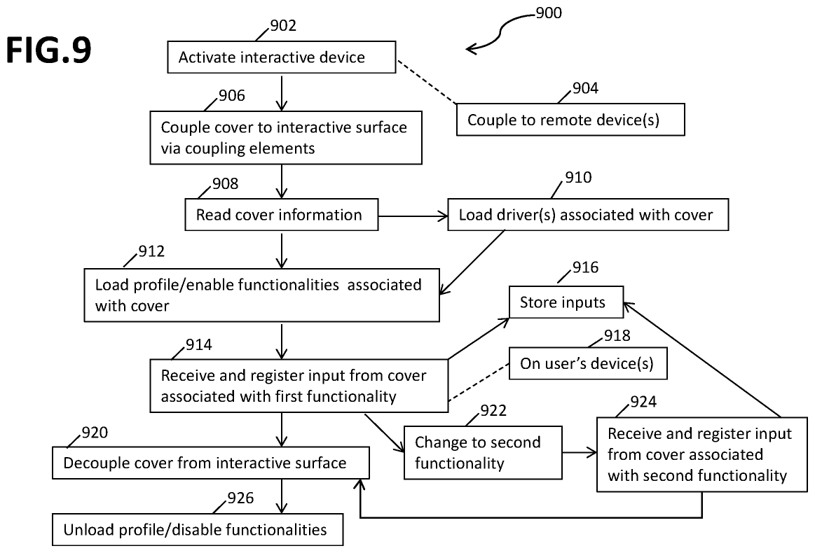

FIG. 9 is a flowchart of a method 900 of using an interactive surface system according to various examples. In the method 900, at block 902, an interactive device is activated, e.g., powered on. This powering-on, or awakening if the device comprises a sleep/wake function, may be via physical inputs such as a button, biometric input(s), haptic inputs, voice inputs, or other means or combinations of means. In some examples, at block 904, the subject interactive device of the method 900 may be wirelessly coupled or coupled by hard lines (wires) to a remote device or devices. These remote devices at block 904 may comprise laptops, desktops, mobile phones, tablets, wearable technology, or other devices. At block 906, a passive or active accessory cover is coupled to the interactive device via a coupling mechanism in the cover that couples to a coupling mechanism in the interactive device. This coupling may mechanically and electrically couple the interactive device to the accessory cover. It is to be appreciated that the coupling at block 904 may occur prior to activation at block 902 or subsequent to activation at block 902.

In an example, at block 908, an application stored on the interactive device may read/retrieve a cover profile from the cover via the coupling mechanism of the cover (e.g., a magnet or magnets), or from a passive chip included in the cover. In an example where the cover is an active cover as discussed above, the cover profile read at block 908 may further comprise information from a non-transitory memory of the cover, and may further include, at block 910, the application of the interactive device downloading a driver associated with the active cover or with a class or type of cover from a remote server based upon the cover profile. At block 912, regardless of whether the cover is active or passive, an at least one functionality is enabled based on the cover profile retrieved at block 908 and/or the driver loaded at block 910. This functionality may include sound, touch recognition, tactile or haptic features, and may in some examples be referred to as a profile that encompasses an identity of the user of the system as indicated by a biometric input or other authentication method or combinations thereof.

In the example method 900, at block 914 the application of the interactive surface receives at least one input via the cover and registers the input on the interactive surface and/or, at block 918, on the remote (user) device or devices that the interactive surface was previously coupled to at block 904. This input may generate an output such as a marking or plurality of markings for a passive or active cover example, or, in an example where an active cover is employed, the output may comprise an audio output, a video output, and/or execution of an application stored in the active cover, interactive device, and/or remote device(s) discussed at block 904. In some examples, at block 916, the inputs received at block 914 may be stored on the interactive device or on the user(s) devices, or otherwise backed up on a remote server including a cloud.

In another example, at block 922, such as when an active cover is employed, a second functionality may be accessed and/or loaded in a similar fashion to what is discussed above with respect to blocks 908, 910, and 912. At block 924, in the example of an active cover, the interactive device receives and registers a second input via the second functionality which may be stored at block 916 as discussed above. At block 920, regardless of whether the cover is active or passive, the cover may be decoupled from the interactive surface by disengaging the coupling mechanisms. At block 926, the functionalities and/or profile previously loaded at block 912, the profile and/or functionalities are unloaded in response to the uncoupling. In the case of an active cover, any drivers loaded at block 910 by the interactive device are removed at block 926 as well. In some examples, the second functionality may be enabled at block 922 by de-coupling a module from an active cover, such module comprising integrated electronics that enable communication with the remainder of the active cover and/or the interactive device. The module may be deactivated upon reassembly to the rest of the active cover (not shown).

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An interactive surface system, comprising:
an interactive device comprising:
a front interactive surface region;
a back region;
a first coupling mechanism;
a printed circuit board (PCB); and
an accessory cover comprising a microchip, a second coupling mechanism, and a cover profile associated with the accessory cover,
wherein, in a first state, the interactive device is to associate with a first functionality,
wherein, in a second state, the accessory cover is to removably couple to the front interactive surface region via the first and second coupling mechanisms, and
wherein, in the second state and in response to the coupling, the interactive device is to load the cover profile based on at least one of the second coupling mechanism and the microchip and is associated with a second functionality.

2. The system of claim 1, wherein the cover profile is stored on the second coupling mechanism.

3. The system of claim 1, wherein the cover profile is stored on the microchip.

4. The system of claim 1, wherein the interactive device is associated with a first height and a first width and the accessory cover is associated with a second height and a second width.

5. The system of claim 4, wherein at least one of the first height and the first width is different from both the second height and the second width.

6. The system of claim 4, wherein the first height is substantially similar to the second height and the first width is substantially similar to the second width.

7. An interactive surface system, comprising:
an interactive device comprising:
a front interactive surface region;
a back region;
a first coupling mechanism;
a printed circuit board (PCB); and
a cover comprising a microchip, a second coupling mechanism, a motor, a battery coupled to the motor, and a cover profile,
wherein, in a first state, the interactive device is to associate with a first functionality,
wherein, in a second state, the cover is to removably couple to the front interactive surface region via the first and second coupling mechanisms, and
wherein, in the second state and in response to the coupling, an application stored on the interactive device and executable by a processor is to load the cover profile based on at least one of the second coupling mechanism and the microchip and is associated with a second functionality.

8. The system of claim 7, wherein the front interactive surface region extends to an outer edge of the interactive device and comprises the first coupling mechanism.

9. The system of claim 7, wherein a portion of the front interactive surface region extends to an inactive border region.

10. The system of claim 9, wherein the inactive border region comprises the first coupling mechanism.

11. The system of claim 7, wherein, when configured in the second state, the battery of the cover is to power the motor.

12. The system of claim 7, further comprising a biometric sensor, wherein the application is to receive an input via the biometric sensor, and wherein the application is to load the cover profile further based on the input received.

13. A method of use of an interactive surface system, comprising:
loading, by an application stored in a non-transitory computer-readable medium of an interactive device, a cover profile stored in an accessory cover,
wherein the interactive device comprises an interactive surface and a first coupling mechanism to removably couple to a second coupling mechanism of the accessory cover;
wherein the cover profile is to be loaded in response to the accessory cover being removably coupled to the interactive device;
executing, by the application and subsequent to loading the cover profile and in response to receiving a plurality of inputs from the accessory cover, at least one functionality of the accessory cover;
decoupling the accessory cover from the interactive device; and
unloading, by the application, the cover profile from the interactive device in response to a determination that the accessory cover is decoupled from the interactive device.

14. The method of claim 13, further comprising:
loading, by the application, a driver associated with the accessory cover based on the cover profile of the accessory cover, wherein the accessory cover profile comprises a state of the accessory cover, a model, a manufacturer, a brand, a plurality of functionalities, an indication of modularity, and a plurality of use rules.

15. The method of claim 13, further comprising:
receiving, by the application via a biometric sensor of the interactive device, a biometric input, wherein loading the cover profile further comprises loading the cover profile based upon the biometric input.
